(19) United States
(12) Patent Application Publication
(10) Pub. No.: US 2025/0135344 A1
(43) Pub. Date: May 1, 2025

(54) GAME RESOURCE PROCESSING METHOD AND APPARATUS, DEVICE, AND STORAGE MEDIUM

(71) Applicant: NETEASE (HANGZHOU) NETWORK CO., LTD., Hangzhou (CN)

(72) Inventor: Bozhang YUAN, Hangzhou (CN)

(21) Appl. No.: 18/837,166

(22) PCT Filed: Mar. 3, 2023
(86) PCT No.: PCT/CN2023/079557

§ 371 Date: Aug. 8, 2024

(30) Foreign Application Priority Data
Mar. 8, 2022 (CN) 202210220648.4

(51) Int. Cl. A63F 13/5372; A63F 13/5375

(52) U.S. Cl. CPC A63F 13/5372; A63F 13/5375

(57) ABSTRACT

In one aspect, a method includes determining, from among a plurality of resource processing nodes in a game scene, a downstream resource processing node corresponding to at least one resource processing node, an input resource of the corresponding downstream resource processing node being an output resource of the at least one resource processing node; respectively connecting the at least one resource processing node and the corresponding downstream resource processing node to generate a virtual production line between the at least one resource processing node and the corresponding downstream resource processing node; and displaying the virtual production line on a graphical user interface.

### CROSS REFERENCE TO RELATED APPLICATIONS

The present disclosure is a 371 national phase of PCT/CN2023/079557 filed Mar. 3, 2023, which claims the priority of Chinese Patent Application No. 202210220648.4, entitled “GAME RESOURCE PROCESSING METHOD AND APPARATUS, DEVICE, AND STORAGE MEDIUM” filed on Mar. 8, 2022, the entire contents of both of which applications are incorporated into the present disclosure by reference for all purposes.

### TECHNICAL FIELD

The present disclosure relates to the technical field of computers, and in particular, to a game resource processing method and apparatus, a device, and a storage medium.

### BACKGROUND ART

In business and strategy simulation mobile games, there are more and more gameplay designs in which production lines exist, i.e., a material is produced from basic resources, then one or more new materials are produced by using the material as a raw material, and one or more production line branches are developed, which often represents an automatic circulation operation.

At present, a plurality of production lines may exist at the same time in a game, and in most cases, they are interlaced with each other to form a non-tree-like trunkless topological structure. Players need to remember the relationships among the production lines of various materials, which causes cognitive and memory costs to be high and the gaming experience to be poor.

### SUMMARY

In a first aspect, the present disclosure provides a game resource processing method. The method comprises: determining, from among the plurality of resource processing nodes in a game scene, a downstream resource processing node corresponding to at least one resource processing node, an input resource of the corresponding downstream resource processing node being an output resource of the at least one resource processing node; respectively connecting the at least one resource processing node and the corresponding downstream resource processing node to generate a virtual production line between the at least one resource processing node and the corresponding downstream resource processing node; and displaying the virtual production line on a graphical user interface.

In a second aspect, the present disclosure provides a system comprising: one or more processors, one or more memories storing computer-executable instructions. The one or more processors execute the computer-executable instructions to perform the operations in the method of the first aspect.

In a third aspect, the present disclosure provides a non-transitory computer-readable storage medium that stores a computer program, and the computer program, when run by one or more processors, performs the operations in the method of the first aspect.

### BRIEF DESCRIPTION OF THE DRAWINGS

To illustrate the technical solutions of the embodiments of the present disclosure more clearly, the accompanying drawings required to be used in the embodiments will be briefly described below. It should be understood that the following accompanying drawings merely illustrate certain embodiments of the present disclosure and are therefore not to be considered limiting of its scope. Those of ordinary skill in the art may still derive other related accompanying drawings according to these accompanying drawings without requiring the exercise of inventive effort.

FIG. 1 shows a first schematic flowchart of a game resource processing method provided by one of the embodiments of the present disclosure;

FIG. 2 shows a second schematic flowchart of the game resource processing method provided by one of the embodiments of the present disclosure;

FIG. 3 shows a first schematic interface diagram of a graphical user interface provided by one of the embodiments of the present disclosure;

FIG. 4 shows a third schematic flowchart of the game resource processing method provided by one of the embodiments of the present disclosure;

FIG. 5 shows a second schematic interface diagram of the graphical user interface provided by one of the embodiments of the present disclosure;

FIG. 6 shows a fourth schematic flowchart of the game resource processing method provided by one the of embodiments of the present disclosure;

FIG. 7 shows a third schematic interface diagram of the graphical user interface provided by one of the embodiments of the present disclosure;

FIG. 8 shows a fifth schematic flowchart of the game resource processing method provided by one of the embodiments of the present disclosure;

FIG. 9 shows a fourth schematic interface diagram of the graphical user interface provided by one of the embodiments of the present disclosure;

FIG. 10 shows a sixth schematic flowchart of the game resource processing method provided by one of the embodiments of the present disclosure;

FIG. 11 shows a fifth schematic interface diagram of the graphical user interface provided by one of the embodiments of the present disclosure;

FIG. 12 shows a sixth schematic interface diagram of the graphical user interface provided by one of the embodiments of the present disclosure;

FIG. 13 shows a schematic structural diagram of a game resource processing apparatus provided by one of the embodiments of the present disclosure; and

FIG. 14 shows a schematic structural diagram of a terminal device provided by one of the embodiments of the present disclosure.

### DETAILED DESCRIPTION

To make the objective, technical solutions, and advantages of the embodiments of the present disclosure clearer, the technical solutions in the embodiments of the present disclosure will be clearly and completely described below with reference to the accompanying drawings in the embodiments of the present disclosure, and it should be understood that the accompanying drawings in the present disclosure are only for the purpose of illustration and description, and are not intended to limit the scope of protection of the present disclosure. In addition, it should be understood that the schematic accompanying drawings are not drawn to scale. The flowcharts used in the present disclosure illustrate operations implemented according to some embodiments of the present disclosure. It should be understood that the operations of the flowcharts may be implemented out of order, and that steps without a logical contextual relationship may be implemented in reverse order or concurrently. Furthermore, those skilled in the art, under the guidance of the content of the present disclosure, may add one or more other operations to the flowcharts or may remove one or more operations from the flowcharts.

In addition, the described embodiments are merely a part, rather than all, of the embodiments of the present disclosure. The assemblies of the embodiments of the present disclosure, which are generally described and illustrated in the accompanying drawings herein, may be arranged and designed in a wide variety of different configurations. Therefore, the following detailed description of the embodiments of the present disclosure provided in the accompanying drawings is not intended to limit the scope of the present disclosure as claimed, but is merely representative of selected embodiments of the present disclosure. All other embodiments obtained by those skilled in the art on the basis of the embodiments of the present disclosure without requiring the exercise of inventive effort fall within the scope of protection of the present disclosure.

It should be noted that the term “include” will be used in the embodiments of the present disclosure to indicate the presence of features stated thereafter, but does not exclude the addition of other features.

In business and strategy simulation mobile games, a plurality of such production lines will exist at the same time, and in many cases, they are interlaced with each other to form a non-tree-like trunkless topological structure. When there is no assistance, the cognitive and memory costs to a player of production planning ideas are increased, and the player needs to remember the relationships among the production lines of various materials and the locations of their output points, the two being mostly unrelated. Players recognize and remember buildings by means of the appearances of the buildings and layout locations at the time of construction, and after being offline for a period of time, they often need to refresh their memory or restructure a city to help with recollection. However, as a game progresses, new buildings will be introduced, and there will be certain obstacles in the scene, such that the original layout needs to be changed again. This leads to a repeated load and a negative experience, affects retention, and destroys the target experience of relaxation and leisure of games.

Furthermore, players cannot recognize the output progress and circulation speed of each resource point, and can only perceive them when production lines are interrupted, so the occurrence of problems cannot be prevented, and the same problem will occur many times, which further causes repeated negative experiences.

Based on this, two methods are provided in the prior art. In a first method, a resource conveying hub is included in a gameplay design to allow players to construct and connect various links of production lines, however, the setting of laying out the resource hub causes large limitations on the story and the gameplay design. A construction production line is added, and the length of the construction production line is related to a resource production speed. Thus, the degree of freedom of a player for a game layout is limited, This method increases player's cognition, planning, operation steps, and error rate, and is relatively hardcore and does not match the easy-to-operate and leisurely category features and target experience of business simulation mobile games. The player's cognitive and memory cost issues for material production means and corresponding locations remain.

In a second method, a production line breakpoint prompt is added in a game, however, production relationships are not displayed, and players still need to remember the material shortage production means and then search for the location of a production point. Players only understand the relationships among production lines and do not know the operation states of the production lines. Players thus cannot plan better production lines to avoid the issues. A problem of insufficient production capacity will reappear, which creates a sense of loss of control.

To sum up, in the game resource processing method provided by the present disclosure, by means of identifying a downstream resource processing node corresponding to at least one resource processing node, respectively connecting the at least one resource processing node and the corresponding downstream resource processing nodes to generate a virtual production line between the at least one resource processing node and the downstream resource processing node, and displaying the virtual production line on a graphical user interface, the cognitive and memory costs of a player for resource types, production relationships, and output point locations can be greatly reduced, and the gameplay of the production line will be better achieved. Information display is more structured, more comprehensive, rational, and timely, and intuitive visual assistance is provided for the player to help the player to form ideas for managing the production line, so the ease of use is greatly enhanced, and the core experience of games is satisfied. The player can find problems before the production line breaks down, and can generate more dimensional and interesting strategic thinking from a global view. Furthermore, there is no limitation on the story and the gameplay design, and an organic combination of gameplays in a production mode and a general mode is achieved.

The game resource processing method in one embodiment of the present disclosure may run on a local terminal device or a server. When the game resource processing method runs on a server, the method may be implemented and performed on the basis of a cloud interaction system, wherein the cloud interaction system includes a server and a client device.

In an example of the present disclosure, various cloud applications may be run under the cloud interaction system, for example: cloud gaming. Using cloud gaming as an example, cloud gaming refers to a gaming means based on cloud computing. In a running mode of the cloud gaming, a running main body of a game program and a game screen presentation main body are separate, the storing and running of the game resource processing method are completed on a cloud game server, and a client device functions to receive and send data and present game screens. For example, the client device may be a display device having a data transmission function close to the player side, such as a mobile terminal, a television, a computer, and a handheld computer. However, information processing is performed by the cloud game server in the cloud. When a game is played, a player operates the client device to send an operation instruction to the cloud game server, the cloud game server runs the game according to the operation instruction, encodes and compresses data such as a game screen, returns the data to the client device via a network, and finally decodes and outputs the game screen by means of the client device.

In an example of the present disclosure, using a game as an example, a local terminal device stores a game program and is used to present game screens. The local terminal device is used to interact with a player via a graphical user interface, i.e., conventionally download and install the game program via an electronic device and run the game program. The local terminal device may provide the graphical user interface to the player in a variety of ways, for example, the graphical user interface may be rendered on a display screen of a terminal, or may be provided to the player by means of holographic projection. For example, the local terminal device may include a display screen and a processor, the display screen being used for presenting the graphical user interface including a game screen, and the processor being used for running the game, generating the graphical user interface, and controlling the display of the graphical user interface on the display screen.

In a possible implementation, an embodiment of the present disclosure provides a game resource processing method in which a graphical user interface is provided by means of a terminal device, wherein the terminal device may be the local terminal device mentioned above, or may also be the client device in the cloud interaction system mentioned above.

The advantageous effects of the present disclosure may include, but are not limited to, reducing the cognitive and memory costs of a player for the virtual production line in a game, providing intuitive visual assistance, improving the gaming experience, reducing the operation costs and running duration of the game in the terminal device, and saving the power of the terminal device.

The game resource processing method provided by the present disclosure will be described in detail below with reference to several specific embodiments.

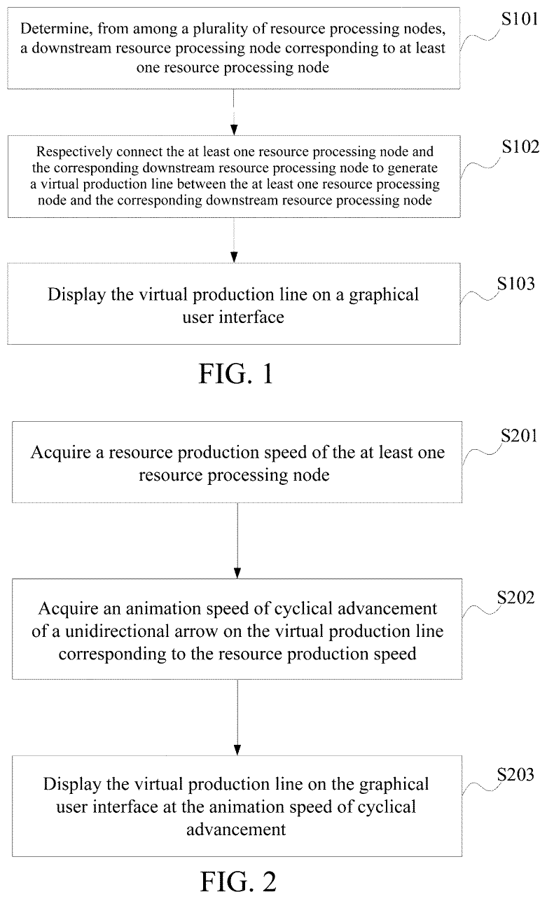

FIG. 1 shows a first schematic flowchart of a game resource processing method provided by an embodiment of the present disclosure, and an execution main body of the embodiment may be a terminal device, for example, a device having a data processing capability, such as a mobile phone, a game console, or a computer.

As shown in FIG. 1, the method may include:

S101: determining, from among a plurality of resource processing nodes, a downstream resource processing node corresponding to at least one resource processing node.

A game scene in the present embodiment may be a game scene of any business and strategy simulation mobile game. In general, after a player downloads and installs a mobile game, the mobile game may be logged into by means of an account, a graphical user interface is provided by means of a terminal device, a plurality of resource processing nodes in the game scene are displayed on the graphical user interface, and the resource processing nodes are configured to receive input resources and produce output resources, that is, the resource processing nodes use received input resources as raw materials to produce output resources.

Generally, there are two types of resource processing nodes in the game scene: an upstream resource processing node and a downstream resource processing node, wherein an output resource of the upstream resource processing node is an input resource of the downstream resource processing node, the downstream resource processing node is configured to consume the output resource of the upstream resource processing node, the upstream resource processing node may include, for example, a coal briquette plant and a timber mill, and the downstream resource processing node may include, for example, a refined coal plant, a high-purity coal mine plant, a kerosene factory, a cinder handling plant, a wood-working factory, and the like.

In some examples, a plurality of resource processing nodes in the game scene are displayed on the graphical user interface, and a downstream resource processing node corresponding to at least one resource processing node is determined from among the plurality of resource processing nodes, an input resource of the downstream resource processing node being an output resource of the corresponding resource processing node, that is, the downstream resource processing node is a consumption node of the corresponding resource processing node, and the corresponding resource processing node is a production node of the downstream resource processing node.

S102: respectively connecting the at least one resource processing node and the corresponding downstream resource processing node to generate a virtual production line between the at least one resource processing node and the corresponding downstream resource processing node.

S103: displaying the virtual production line on the graphical user interface.

The at least one resource processing node and the corresponding downstream resource processing node are respectively connected to generate a virtual production line between the at least one resource processing node and the corresponding downstream resource processing node, and then the virtual production line is displayed on the graphical user interface, wherein the at least one resource processing node may be an upstream resource processing node, and each resource processing node among the at least one resource processing node may correspond to at least one downstream resource processing node.

It should be noted that the virtual production line in the present embodiment is used to respectively connect at least one resource processing node and a corresponding downstream resource processing node, while in the prior art, the length of an added constructed production line is related to a resource production speed, which results in the degree of freedom of a player for a game layout being limited. Therefore, the virtual production line in the present embodiment does not limit the free laying out by players for games.

In some examples, in step S101, the method may further include:
in response to a touch operation acting on a mode switching control on the graphical user interface, switching a game mode to a preset production mode in which other game information besides the plurality of resource processing nodes in the game scene is hidden.

That is, the mode switching control is provided on the graphical user interface, the game scene provides a specific display mode, and the game mode, by means of the touch operation acting on the mode switching control on the graphical user interface, may be switched from a general mode to the preset production mode in which other game information besides the plurality of resource processing nodes in the game scene is hidden. The other game information besides the plurality of resource processing nodes may include information displayed by a user interface (UI) layer, for example, collected bubbles, various types of prompt information, state information, and the like. In this way, an organic combination of gameplays in the production mode and the general mode is achieved, and the independent states, the relationships, and the overall state of the resource processing nodes can be dynamically displayed without being disturbed by other information.

In addition, some operation logics that conflict with operation logics in the preset production mode may be shielded in the preset production mode, for example, a collection instruction or the like that may be triggered by a point-and-click on a building (resource processing node). This is because clicking on a building in the preset production mode may trigger a different instruction. Of course, it is also possible to hide irrelevant UI controls, weaken game scenes, etc., in the preset production mode, if necessary.

It should be noted that easy switching between the preset production mode and the general mode may be performed by means of the mode switching control.

In the game resource processing method according to the present embodiment, a downstream resource processing node corresponding to at least one resource processing node is determined from among a plurality of resource processing nodes, an input resource of the downstream resource processing node being an output resource of the corresponding resource processing node, the at least one resource processing node and the corresponding downstream resource processing node are respectively connected to generate a virtual production line between the at least one resource processing node and the corresponding downstream resource processing node, and the virtual production line is displayed on a graphical user interface. The cognitive and memory costs of a player for resource types, production relationships, and output point locations can be greatly reduced. Intuitive visual assistance is provided for the player to help the player to form ideas for managing the production line, so the ease of use is greatly enhanced, and the core experience of games is satisfied. The player can find problems before the production line breaks down, and can generate more dimensional and interesting strategic thinking from a global view. There is no limitation on the story and the gameplay design, the gaming experience is improved, the operation costs and running duration of the game in the terminal device are reduced, and the power of the terminal device is saved.

FIG. 2 shows a second schematic flowchart of the game resource processing method provided by an embodiment of the present disclosure, and as shown in FIG. 2, step S103 in which the virtual production line is displayed on the graphical user interface includes:

S201: acquiring a resource production speed of the at least one resource processing node.

S202: acquiring an animation speed of cyclical advancement of a unidirectional arrow on the virtual production line corresponding to the resource production speed.

The unidirectional arrow may be provided on the virtual production line, the unidirectional arrow may be directed from the at least one resource processing node to a corresponding downstream resource processing node, the unidirectional arrow may be in a cyclical advancement state, and an animation may be displayed in a cyclically advancement state, that is, conveyance of a resource from the at least one resource processing node to the corresponding downstream resource processing node is indicated by a dynamic unidirectional arrow that cyclically advances, wherein each resource processing node among the at least one resource processing node corresponds to at least one downstream resource processing node.

The at least one resource processing node is configured to produce and output a resource to the corresponding downstream resource processing node, and acquires the resource production speed of the at least one resource processing node, wherein the resource production speed may be a quantity of the resource produced per unit of time, and the resource production speed has a certain mapping relationship with the animation speed of cyclical advancement of the unidirectional arrow. In general, the resource production speed has a positive correlation with the animation speed of cyclical advancement, such that the faster the resource production speed, the faster the animation speed of cyclical advancement of the unidirectional arrow, i.e., the faster the unidirectional arrow cyclically moves, the faster the resource production speed, and the slower the animation speed of cyclical advancement of the unidirectional arrow, i.e., the slower the unidirectional arrow cyclically moves.

S203: displaying the virtual production line on the graphical user interface at the animation speed of cyclical advancement.

After the unidirectional arrow is provided on the virtual production line and the animation speed of cyclical advancement is obtained, the virtual production line may be displayed on the graphical user interface at the animation speed of cyclical advancement, so that when the virtual production line is directed from each resource processing node to a corresponding downstream resource processing node, the resource production speed of the at least one resource processing node may be determined by means of the animation speed of cyclical advancement on the virtual production line.

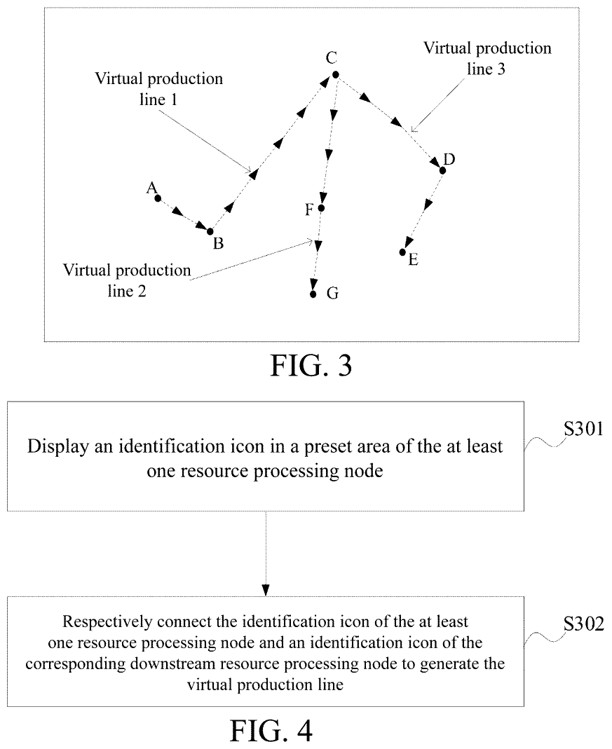

FIG. 3 shows a first schematic interface diagram of a graphical user interface provided by an embodiment of the present disclosure, and as shown in FIG. 3, three virtual production lines (shown as dotted lines in FIG. 3) are displayed on the graphical user interface, resource processing nodes on virtual production line 1 are A, B, and C, resource processing nodes on virtual production line 2 are C, F, and G, and resource processing nodes on virtual production line 3 are C, D, and E. A unidirectional arrow is provided on each of the virtual production lines, the unidirectional arrow moves dynamically, an animation speed of cyclical advancement of the unidirectional arrow may be acquired according to a resource production speed of at least one resource processing node, and different resource production speeds correspond to different animation speeds.

In the game resource processing method according to the present embodiment, a resource production speed of at least one resource processing node is acquired, and an animation speed of cyclical advancement of a unidirectional arrow on a virtual production line corresponding to the resource production speed is acquired, wherein the unidirectional arrow is directed from the at least one resource processing node to a corresponding downstream resource processing node to display the virtual production line at the animation speed of cyclical advancement. The resource production speed is represented by means of a movement speed of the unidirectional arrow, so that the gameplay of the production line is better represented. Intuitive visual assistance is provided for the player to help the player to form ideas for managing the production line, so the ease of use is greatly enhanced, and the core experience of games is satisfied. The gaming experience is improved, the operation costs and running duration of the game in a terminal device are reduced, and the power of the terminal device is saved.

FIG. 4 shows a third schematic flowchart of the game resource processing method provided by an embodiment of the present disclosure, and as shown in FIG. 4, step S102in which the at least one resource processing node and the corresponding downstream resource processing node are respectively connected to generate a virtual production line between the at least one resource processing node and the corresponding downstream resource processing node includes:

S301: displaying an identification icon in a preset area of the at least one resource processing node.

S302: respectively connecting the identification icon of the at least one resource processing node and an identification icon of the corresponding downstream resource processing node to generate the virtual production line.

The preset area of the at least one resource processing node may be a preset area centered on the at least one resource processing node. The preset area may be a circular area or a square area centered on the at least one resource processing node, and the preset area is not particularly limited in the present embodiment.

The identification icon is used to identify at least one resource processing node. Using the resource processing node being a coal plant as an example, an identification icon of the coal plant may be an icon identifying a building of the coal plant.

The identification icon of the resource processing node is displayed in the preset area of the at least one resource processing node, and then the identification icon of the at least one resource processing node and the identification icon of the corresponding downstream resource processing node are respectively connected to generate the virtual production line between the at least one resource processing node and the corresponding downstream resource processing node.

Step S103 may then be performed to display the virtual production line on the graphical user interface.

In some examples, if the number of the virtual production line in a game scene increases so that the virtual production lines are visually intricate and complicated and form a topological structure, in order to facilitate a player to screen out a virtual production line that the player desires to focus on, after the virtual production lines are displayed on the graphical user interface in step S103, the method may further include:
in response to a selection operation acting on any identification icon, canceling display of other virtual production lines besides the virtual production line to which the any identification icon is connected.

The selection operation may be a touch operation, for example, may be a tap operation, a long press operation, or any type of a tap operation.

The player may input a selection operation acting on any identification icon on the graphical user interface, such that in response to the selection operation, display of other virtual production lines besides the virtual production line to which the any identification icon is connected is canceled, that is, the virtual production line to which the any identification icon is connected is screened out, and the other virtual production lines are hidden, thereby achieving screening of the resource processing nodes.

In some examples, after the display of the other virtual production lines is canceled, the method may further include:
in response to the selection operation acting on the any identification icon, displaying the other virtual production lines.

Alternatively, in response to a touch operation acting on a blank area on the graphical user interface, the other virtual production lines are displayed.

The selection operation may be a touch operation, for example, may be a tap operation, a long press operation, or any type of a tap operation.

The player inputs the selection operation acting on the any identification icon, such that in response to the selection operation acting on the any identification icon, the display of the other virtual production lines can be resumed. Alternatively, the player inputs the touch operation acting on the blank area in the game scene, such that in response to the touch operation acting on the blank area, the display of the other virtual production lines is resumed. This allows the player to quickly screen and adjust the display of the production lines.

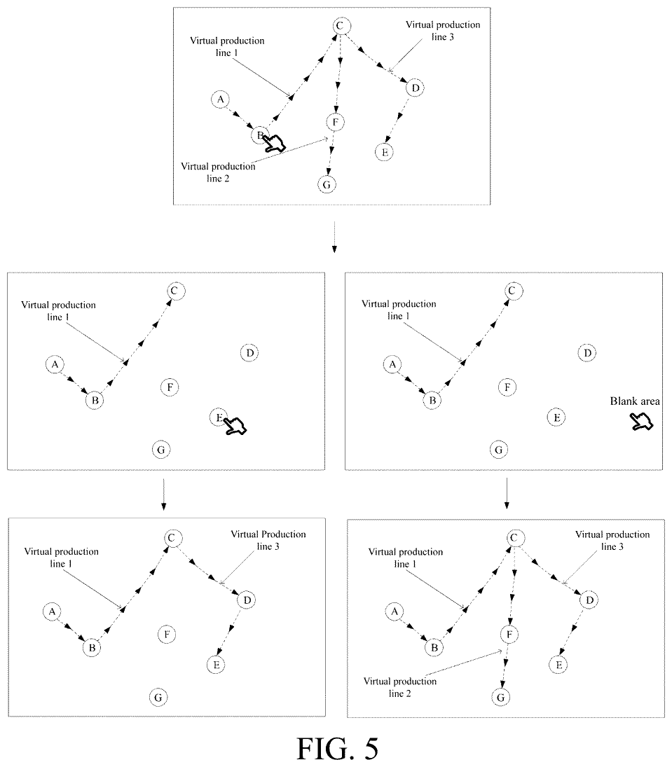

FIG. 5 shows a second schematic interface diagram of the graphical user interface provided by an embodiment of the present disclosure, and as shown in FIG. 5, based on FIG. 3, a bubble icon, i.e., the identification icon, is displayed in the preset area of the at least one resource processing node, and the bubble icon of the at least one resource processing node and a bubble icon of a corresponding downstream resource processing node are respectively connected to generate the virtual production lines, i.e., virtual production line 1, virtual production line 2, and virtual production line 3 in FIG. 5.

The player can input a selection operation acting on an identification icon of resource processing node B to cancel the display of other virtual production lines besides the virtual production line to which the identification icon of resource processing node B is connected, that is, cancel the display of virtual production line 2 and virtual production line 3. Of course, when the player selects the identification icon of resource processing node B, resource processing information of resource processing node B may also be displayed in a game scene, for example, the name (food processing plant), function (food concentration), production capacity (normal) of resource processing node B, and an adjustment control for adjusting the resource processing information, and the like may be included.

Then, the player may further input a selection operation acting on any identification icon (i.e., an identification icon corresponding to resource processing node E) on virtual production line 3 to resume display of virtual production line 3, or input a touch operation acting on a blank area in the game scene to resume display of virtual production line 2 and virtual production line 3. In some examples, the method further includes:
in response to a style change operation acting on any resource processing node among the at least one resource processing node, switching a display means of an identification icon of the any resource processing node.

The style change operation acting on the any resource processing node may be a style change operation acting on the identification icon of the any resource processing node, and the style change operation may be a touch operation, for example, may be a tap operation, a long press operation, or any type of a tap operation.

In some examples of the present disclosure, a style change control is provided in the game scene, and the style change operation acting on the any resource processing node may include: a touch operation for the identification icon of the any resource processing node and a touch operation acting on the style change control in turn. In such a way, by means of sequentially touching the identification icon of the any resource processing node and the style change control, the display means of the identification icon of the any resource processing node can be switched. As a result, the display means of the identification icon of the any resource processing node is different from the display means of the identification icons of other resource processing nodes, and thus the any resource processing node can be emphasized.

It should be noted that the display means of the identification icon of the resource processing node includes standard display, highlighted display, high-definition display, high-contrast display, and the like. The display means can be switched among the display means provided in the game scene as long as the style changing operation is performed, and the display means is not particularly limited in the present embodiment.

In the game resource processing method according to the present embodiment, the identification icon is displayed in the preset area of the at least one resource processing node, and the identification icon of the at least one resource processing node and the identification icon of the corresponding downstream resource processing node are respectively connected to generate the virtual production line. The cognitive and memory costs of a player for resource types, production relationships, and output point locations can be greatly reduced. Intuitive visual assistance is provided for the player to help the player to form ideas for managing the production line, so the ease of use is greatly enhanced, and the core experience of games is satisfied. The player can find problems before the production line breaks down, and can generate more dimensional and interesting strategic thinking from a global view. There is no limitation on the story and the gameplay design, the gaming experience is improved, the operation costs and running duration of the game in the terminal device are reduced, and the power of the terminal device is saved.

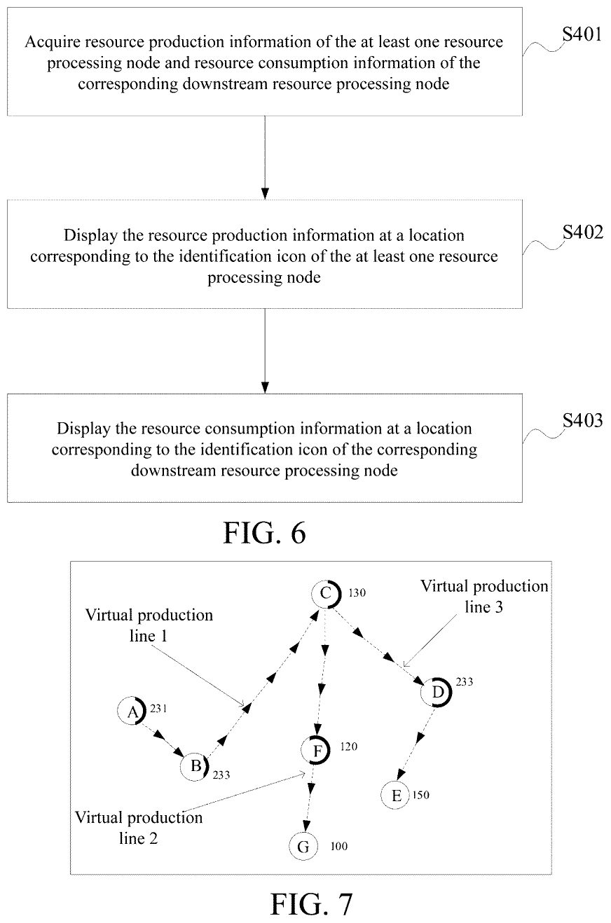

FIG. 6 shows a fourth schematic flowchart of the game resource processing method provided by an embodiment of the present disclosure, and as shown in FIG. 6, based on the embodiment in FIG. 4, the method further includes:

S401: acquiring resource production information of the at least one resource processing node and resource consumption information of the corresponding downstream resource processing node.

The resource production information includes resource production progress and/or resource stock. The resource production progress refers to output progress of a resource being produced by the at least one resource processing node. Generally, a total production amount of a resource of each resource production node is fixed. The resource production progress may be a percentage of the resource being produced compared to the total production amount of the resource. The resource stock refers to an amount of resources stored in a warehouse in a game, and generally, in a simulation game, when there is still a surplus after resources produced by a resource processing node are provided to a corresponding downstream resource processing node, the surplus will be stored in the warehouse.

The resource consumption information includes resource consumption progress and/or a resource consumption state, wherein the resource consumption progress refers to consumption progress of input resources by the corresponding downstream resource processing node, and the resource consumption state refers to a resource consumption state of the input resources consumed by the corresponding downstream resource processing node, and may include, for example, a normal operation state, a reduced production capacity state, an insufficient raw material state, a manpower shortage state, etc.

S402: displaying the resource production information at a location corresponding to the identification icon of the at least one resource processing node.

S403: displaying the resource consumption information at a location corresponding to the identification icon of the corresponding downstream resource processing node.

The location corresponding to the identification icon of the at least one resource processing node may be within a preset range centered on the identification icon of the at least one resource processing node, and the location corresponding to the identification icon of the corresponding downstream resource processing node may be within a preset range centered on the identification icon of the corresponding downstream resource processing node.

After the resource production information of the at least one resource processing node and the resource consumption information of the corresponding downstream resource processing node are acquired, the resource production information may be displayed at the location corresponding to the identification icon of the at least one resource processing node, and the resource consumption information may be displayed at the location corresponding to the identification icon of the corresponding downstream resource processing node.

In this way, a player is facilitated in promptly knowing the complete relationship of the production line and the operating conditions of the at least one resource processing node and the corresponding downstream resource processing node, so that the gameplay of the production line can be better implemented, and information display can be more structured, and more comprehensive, rational, and timely.

In some examples, the resource production information includes: the resource production progress, and the resource consumption information includes: the resource consumption progress.

Step S402 in which the resource production information is displayed at a location corresponding to the identification icon of the at least one resource processing node includes:
displaying the resource production progress on the identification icon of the at least one resource processing node.

Step S403 in which the resource consumption information is displayed at a location corresponding to the identification icon of the corresponding downstream resource processing node includes:
displaying the resource consumption progress on the identification icon of the corresponding downstream resource processing node.

If the resource production information includes the resource production progress, the resource production progress may be displayed on the identification icon of the at least one resource processing node. For example, the identification icon is a circular bubble icon, then the resource production progress may be represented in the form of a progress bar at the edge of the circular bubble icon, and the edge of the entire circular bubble icon represents the resource production progress, that is, the percentage of the resource being produced compared to the total production amount of the resource.

If the resource consumption information includes the resource consumption progress, the resource consumption progress may be displayed on the identification icon of the corresponding downstream resource processing node. For example, the identification icon is a bubble icon, then the resource consumption progress may be displayed in the form of a progress bar at the edge of the bubble icon, and the edge of the entire bubble icon represents the resource consumption progress, that is, the percentage of the resource being consumed compared to the input resources.

If a certain resource processing node serves as both an upstream resource processing node and a downstream resource processing node, the resource production progress and the resource consumption progress may be simultaneously displayed on the bubble icon of the resource processing node in the form of inner circle and outer circle progress bars, or only the resource production progress or the resource consumption progress may be displayed, which may be set specifically according to a game, and is not particularly limited in the present embodiment.

In some examples, the resource production information further includes: the resource stock, and the resource consumption information includes: the resource consumption state.

Step S402 in which the resource production information is displayed at a location corresponding to the identification icon of the at least one resource processing node includes:
displaying the resource stock within a preset range centered on the identification icon of the at least one resource processing node.

Step S403 in which the resource consumption information is displayed at a location corresponding to the identification icon of the corresponding downstream resource processing node includes:
displaying the resource consumption state within a preset range centered on the identification icon of the corresponding downstream resource processing node.

If the resource production information further includes the resource stock, the resource stock may be displayed within the preset range centered on the identification icon of the at least one resource processing node, and the resource consumption state may be displayed within the preset range centered on the identification icon of the corresponding downstream resource processing node.

In this way, a player is facilitated in better implementing the gameplay of the production line, and information display is more structured, more comprehensive, rational, and timely, and intuitive visual assistance is provided to the player to help the player to form ideas for managing the production line, so the ease of use is greatly enhanced, and the core experience of games is satisfied.

Using a resource processing node as an example, FIG. 7 shows a third schematic interface diagram of the graphical user interface provided by an embodiment of the present disclosure. As shown in FIG. 7, based on FIG. 5, the resource production progresses are displayed on the identification icons of the at least one resource processing node. In FIG. 7, the resource production progress is indicated by bold lines at the edges of bubble icons, and the resource stocks are displayed in a peripheral area centered on the bubble icons of the at least one resource processing node, respectively 231, 233, 130, 233, 150, 120, and 100 in FIG. 7. Resource stock identification icons may be displayed at locations corresponding to the resource stocks. In FIG. 7, resource processing node E and resource processing node G are both resource consumption nodes and are not resource production nodes, so resource production progress is not shown in FIG. 7.

In the game resource processing method according to the present embodiment, the resource production information of the at least one resource processing node and the resource consumption information of the corresponding downstream resource processing node are acquired, the resource production information is displayed at the location corresponding to the identification icon of the at least one resource processing node, and the resource consumption information is displayed at the location corresponding to the identification icon of the corresponding downstream resource processing node. The cognitive and memory costs of a player for resource types, production relationships, and output point locations can be greatly reduced, and the gameplay of the production line can be better implemented. Information display can be more structured, more comprehensive, rational, and timely, and the player can find problems before the production line breaks down and can generate more dimensional and interesting strategic thinking from a global view.

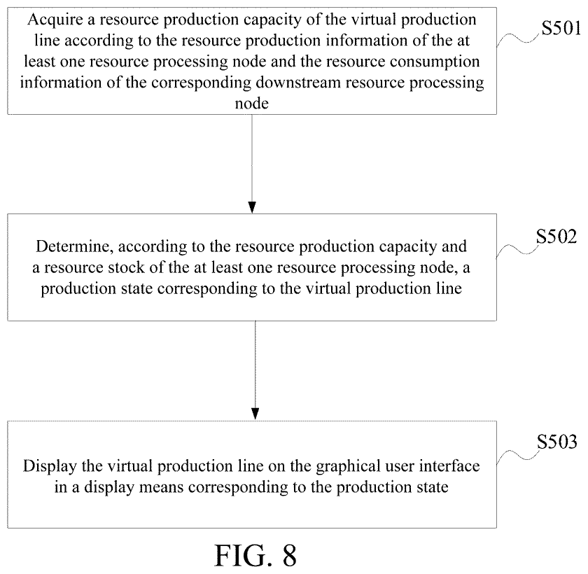

FIG. 8 shows a fifth schematic flowchart of the game resource processing method provided by an embodiment of the present disclosure, and as shown in FIG. 8, step S104 in which the virtual production line is displayed on the graphical user interface includes:

S501: acquiring a resource production capacity of the virtual production line according to the resource production information of the at least one resource processing node and the resource consumption information of the corresponding downstream resource processing node.

S502: determining, according to the resource production capacity and the resource stock of the at least one resource processing node, a production state corresponding to the virtual production line.

S503: displaying the virtual production line on the graphical user interface in a display means corresponding to the production state.

The resource production information includes a resource production speed, the resource consumption information includes a resource consumption speed, and the resource production capacity is the difference between the resource production speed and the resource consumption speed.

The resource production capacity of the virtual production line may be calculated according to the resource production information of the at least one resource processing node and the resource consumption information of the corresponding downstream resource processing node, and then the production state corresponding to the virtual production line may be determined according to the resource production capacity and the resource stock of the at least one resource processing node. Different production states may correspond to different display means, so the virtual production line may be displayed in the display means corresponding to the production state in a game scene.

In some examples, step S503 in which the virtual production line is displayed on the graphical user interface in the display means corresponding to the production state includes:
displaying the virtual production line in a color corresponding to the production state on the graphical user interface.

Different production states correspond to different colors, and after the production state corresponding to the virtual production line is determined, the color corresponding to the production state may be determined, and then the virtual production line may be displayed in the color corresponding to the production state on the graphical user interface.

The production state may include: a production resource shortage state and a production stagnation state, wherein in the production resource shortage state, the resource consumption speed of the downstream resource processing node is greater than the resource production speed of the corresponding upstream resource processing node, and the resource stock of the upstream resource processing node is greater than or equal to a preset amount, so the display means corresponding to the production state may include: the color of the virtual production line is changed to yellow, and the animation speed of cyclical advancement of the unidirectional arrow on the virtual production line is reduced.

The color of the resource production progress bar on the identification icon of the at least one resource processing node may also be changed to yellow, or may be supplemented with an icon or a text description to warn the player, and the warning means is not particularly limited in the present embodiment. The preset amount may be 0 or an amount insufficient for processing, which is not limited in the present embodiment.

In the production stagnation state, the resource consumption speed of the downstream resource processing node is greater than the resource production speed of the corresponding upstream resource processing node, and the resource stock of the upstream resource processing node is less than a preset amount, so the display means corresponding to the production state may include: the color of the virtual production line is changed to red, and the unidirectional arrow stops advancing on the virtual production line.

Of course, the color of the resource production progress bar on the identification icon of the at least one resource processing node may also be changed to red, or may be supplemented with an icon or a text description to strongly warn the player. The strong warning means is not particularly limited in the present embodiment, as long as it can enable the player to distinguish different production states.

In some examples, the method may further include:
if the production state is the production resource shortage state, displaying resource shortage prompt information on the identification icon of the at least one resource processing node, wherein in the production resource shortage state, the at least one resource processing node provides resources to the downstream resource processing node by means of the resource stock.

The resource processing node providing resources to the downstream resource processing node by means of the resource stock indicates that the resource consumption speed of the downstream resource processing node is greater than the resource production speed of the upstream resource processing node, and the resource stock of the upstream resource processing node is greater than or equal to the preset amount, for example, the output and stock of coal are completely consumed, production of refined coal is stopped, and refined coal in an intelligent consumption stock for high-purity coal is produced. Accordingly, it is possible to display the resource shortage prompt information on the identification icon of the at least one resource processing node.

In some examples, the method may further include:
if the production state is the production stagnation state, displaying production stagnation prompt information on the identification icon of the at least one resource processing node, wherein in the production stagnation state, the at least one resource processing node cannot provide resources to the downstream resource processing node.

The resource processing node not being able to provide resources to the downstream resource processing node indicates that the resource consumption speed of the downstream resource processing node is greater than the resource production speed of the upstream resource processing node, and the resource stock of the upstream resource processing node is less than the preset amount, for example, the stock of refined coal is completely consumed, and the production of high-purity coal is stopped accordingly. Accordingly, it is possible to display the production stagnation prompt information on the identification icon of the at least one resource processing node.

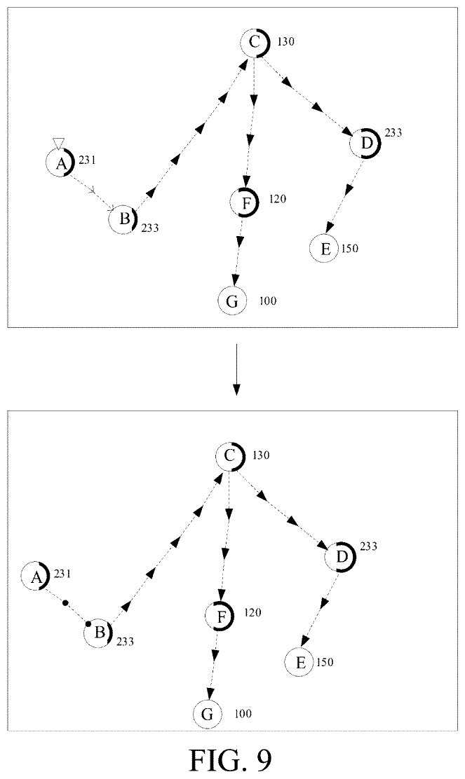

FIG. 9 shows a fourth schematic interface diagram of the graphical user interface provided by an embodiment of the present disclosure. As shown in FIG. 9, based on FIG. 7, if the resource production capacity of virtual production line 1 between resource processing node A and resource processing node B is in the production resource shortage state, virtual production line 1 is displayed in yellow (indicated by a unidirectional arrow different from an original arrow in FIG. 9), so as to warn the player of a production resource shortage.

In addition, the resource shortage prompt information (a triangle in FIG. 9, which may be marked in red) may also be displayed on the identification icon of resource processing node A, and the color of the resource production progress bar on the identification icon of resource processing node A may be displayed in yellow.

In the above, only virtual production line 1 between resource processing node A and resource processing node B is described as an example, and in practical applications, all virtual production lines having insufficient production resources and corresponding identification icons can be marked in this manner.

If the production state of virtual production line 1 between resource processing node A and resource processing node B is changed from the production resource shortage state to the production stagnation state, the color of virtual production line 1 may be changed from yellow to red (indicated by a solid circle in FIG. 9).

In addition, it is also possible to cancel the display of the triangle on the identification icon of resource processing node A and to adjust the color of the resource production progress bar on the identification icon of resource processing node A from yellow to red.

In the game resource processing method according to the present embodiment, the resource production capacity of the virtual production line is acquired according to the resource production information of the at least one resource processing node and the resource consumption information of the corresponding downstream resource processing node, the production state corresponding to the virtual production line is determined according to the resource production capacity and the resource stock of the at least one resource processing node, and the virtual production line is displayed in a display means corresponding to the production state in a game scene. The player can find problems before the production line breaks down, and can generate more dimensional and interesting strategic thinking from a global view, and different warnings may be given to the player according to different production states.

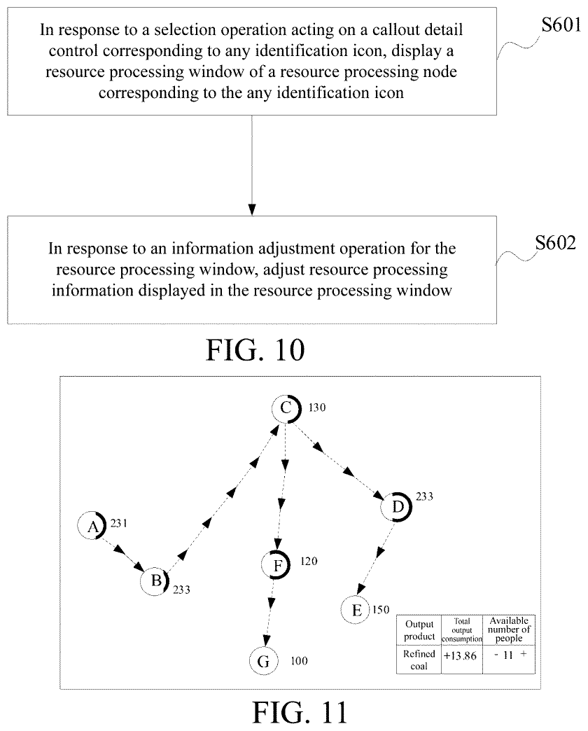

FIG. 10 shows a sixth schematic flowchart of the game resource processing method provided by an embodiment of the present disclosure, and as shown in FIG. 10, the method may further include:

S601: in response to a selection operation acting on a callout detail control corresponding to any identification icon, displaying a resource processing window of a resource processing node corresponding to the any identification icon.

The selection operation may be a touch operation, for example, may be a tap operation, a long press operation, or any type of a tap operation.

A callout detail control corresponding to each identification icon is displayed on the graphical user interface, and when the player inputs the selection operation acting on the callout detail control corresponding to any icon, the resource processing window of the resource processing node corresponding to the any identification icon may be displayed in a game scene, wherein information related to the resource processing node corresponding to the any identification icon when processing a resource is displayed in the resource processing window.

It should be noted that the resource processing information may include the resource production information, the resource consumption information, and resource configuration information, wherein the resource production information may include the resource production progress and the resource stock, the resource consumption information may include the resource consumption progress and the resource consumption state, and the resource configuration information may include an operating temperature, an available number of people, a product type, a total consumption value, and the like.

S602: in response to an information adjustment operation for the resource processing window, adjusting the resource processing information displayed in the resource processing window.

The player may input the information adjustment operation for the resource processing window according to actual demands, and accordingly, a terminal device, in response to the information adjustment operation for the resource processing window, adjusts the resource processing information displayed in the resource processing window. For example, the player inputs an information adjustment operation for the available number of people, and adjusts the available number of people from 10 to 20.

It should be noted that the resource processing window may further provide a jump control and production location information, and the player may input an information adjustment operation for the production location information, adjust a production location of the resource processing node corresponding to the any identification icon, for example, adjust from location A to location B, and then, the jumping of the production location is achieved by means of the jump control.

FIG. 11 shows a fifth schematic interface diagram of the graphical user interface provided by an embodiment of the present disclosure. As shown in FIG. 11, based on FIG. 7, the player inputs the selection operation acting on the callout detail control corresponding to the identification icon of resource processing node E, the resource processing window of resource processing node E is displayed in the game scene, and the resource processing information is displayed in the resource processing window, which may include, for example, three parameters, i.e., output product, total output consumption, and available number of people, and the player may adjust the available number of people by means of “+” and “−” keys.

Of course, the above is only one example of the resource processing information, and this example is intended to illustrate that resource processing information may be adjusted by means of a particular window.

In some examples, the method may further include:
in response to a movement operation acting on a range skill control in the game scene, adjusting the resource processing information of the at least one resource processing node located within a coverage area of the range skill control.

The range skill control is provided in the game scene for adjusting the resource processing information of the resource processing node in the range. The movement operation acting on the range skill control in the game scene refers to a player moving the range skill control to adjust the resource processing information of the at least one resource processing node located within the coverage area of the range skill control.

For example, the resource processing information is the resource production speed, and the range skill control may be used to adjust the production speed of the resource processing node within the range. As a result, the production speed of the resource processing node can be increased in a range, and display of an action target and an effect are clear at a glance.

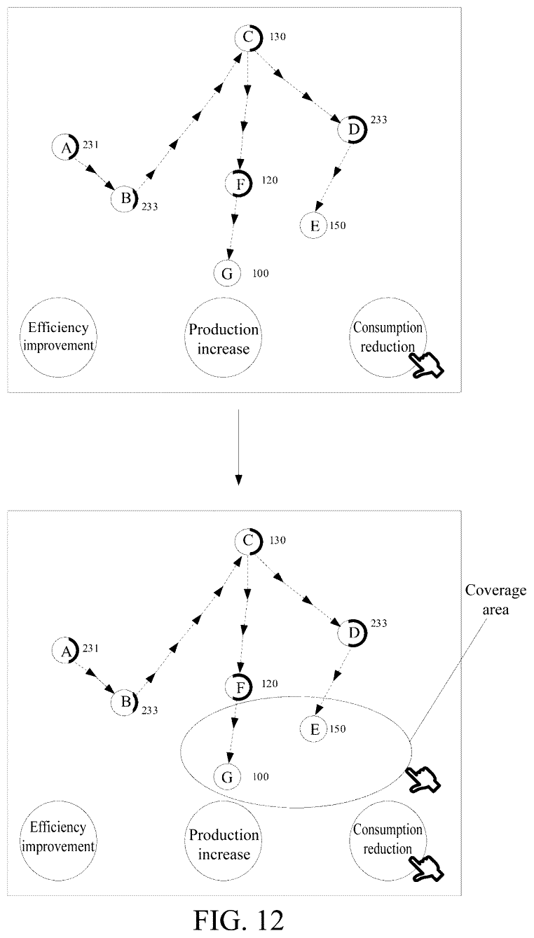

FIG. 12 shows a sixth schematic interface diagram of the graphical user interface provided by an embodiment of the present disclosure. As shown in FIG. 12, based on FIG. 11, three range skill controls are provided in the game scene, which are an efficiency improvement range skill control, a production increase range skill control, and a consumption reduction range skill control, respectively. A user can drag the consumption reduction range skill control into the game scene to reduce consumption of resource processing nodes located in a coverage area of the consumption reduction range skill control. The resource processing nodes located in the coverage area of the consumption reduction range skill control in FIG. 12 include resource processing node E and resource processing node G. Of course, the coverage area can also be moved according to requirements.

In the game resource processing method according to the present embodiment, a resource processing window of a resource processing node corresponding to any identification icon is displayed in a game scene in response to a selection operation acting on a callout detail control corresponding to the any identification icon in the game scene, and resource processing information displayed in the resource processing window is adjusted in response to an information adjustment operation for the resource processing window. Therefore, it is possible to adjust the resource processing information of the resource processing node in a range, so that the operation is convenient, and the action target and the effect are clear at a glance.

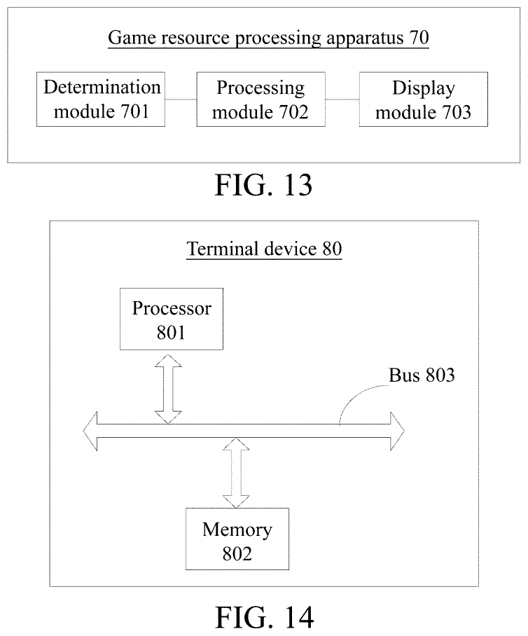

FIG. 13 shows a schematic structural diagram of a game resource processing apparatus provided by an embodiment of the present disclosure, wherein the game resource processing apparatus may be integrated in a terminal device. A graphical user interface is provided by means of a terminal device, a plurality of resource processing nodes in a game scene are displayed on the graphical user interface, and the resource processing nodes are configured to receive input resources and produce output resources.

As shown in FIG. 13, the game resource processing apparatus 70 includes:
a determination module 701, configured to determine, from among the plurality of resource processing nodes, a downstream resource processing node corresponding to at least one resource processing node, an input resource of the downstream resource processing node being an output resource of the corresponding resource processing node;
a processing module 702, configured to respectively connect the at least one resource processing node and the corresponding downstream resource processing node to generate a virtual production line between the at least one resource processing node and the corresponding downstream resource processing node; and
a display module 703, configured to display the virtual production line on the graphical user interface.

In some examples, the display module 703 is specifically configured to:
acquire a resource production speed of the at least one resource processing node;
acquire an animation speed of cyclical advancement of a unidirectional arrow on the virtual production line corresponding to the resource production speed, wherein the unidirectional arrow is directed from the at least one resource processing node to the corresponding downstream resource processing node; and
display the virtual production line on the graphical user interface at the animation speed of cyclical advancement.

In some examples, the processing module 702 is specifically configured to:
display an identification icon in a preset area of the at least one resource processing node; and
respectively connect the identification icon of the at least one resource processing node and an identification icon of the corresponding downstream resource processing node to generate the virtual production line.

In some examples, the apparatus further includes:
an acquisition module 704, configured to acquire resource production information of the at least one resource processing node and resource consumption information of the corresponding downstream resource processing node; and
the display module 703, further configured to display the resource production information at a location corresponding to the identification icon of the at least one resource processing node; and
display the resource consumption information at a location corresponding to the identification icon of the corresponding downstream resource processing node.

In some examples, the resource production information includes: resource production progress, and the resource consumption information includes: resource consumption progress; and
the display module 703 is specifically configured to:
display the resource production progress on the identification icon of the at least one resource processing node; and
display the resource consumption progress on the identification icon of the corresponding downstream resource processing node.

In some examples, the resource production information further includes: resource stock, and the resource consumption information includes: resource consumption state; and
the display module 703 is specifically configured to:
display the resource stock within a preset range centered on the identification icon of the at least one resource processing node; and
display the resource consumption state within a preset range centered on the identification icon of the corresponding downstream resource processing node.

In some examples, the processing module 702 is further configured to:
in response to a style change operation acting on any resource processing node among the at least one resource processing node, switch a display means of an identification icon of the any resource processing node.

In some examples, the display module 703 is specifically configured to:
acquire a resource production capacity of the virtual production line according to the resource production information of the at least one resource processing node and the resource consumption information of the corresponding downstream resource processing node;
determine, according to the resource production capacity and the resource stock of the at least one resource processing node, a production state corresponding to the virtual production line; and
display the virtual production line on the graphical user interface in a display means corresponding to the production state.

In some examples, the display module 703 is specifically configured to:
display the virtual production line in a color corresponding to the production state on the graphical user interface.

In some examples, the display module 703 is further configured to:
if the production state is a production resource shortage state, display resource shortage prompt information on the identification icon of the at least one resource processing node, wherein in the production resource shortage state, the at least one resource processing node provides resources to the downstream resource processing node by means of the resource stock.

In some examples, the display module 703 is further configured to:
if the production state is a production stagnation state, display production stagnation prompt information on the identification icon of the at least one resource processing node, wherein in the production stagnation state, the at least one resource processing node cannot provide resources to the downstream resource processing node.

In some examples, the display module 703 is further configured to:
in response to a selection operation acting on any identification icon, cancel display of other virtual production lines besides the virtual production line to which the any identification icon is connected.

In some examples, the display module 703 is further configured to:
in response to a selection operation acting on the any identification icon, display the virtual production lines; or,
in response to a touch operation acting on a blank area on the graphical user interface, display the other virtual production lines.

In some examples, the display module 703 is further configured to:
in response to a selection operation acting on a callout detail control corresponding to any identification icon, display a resource processing window of a resource processing node corresponding to the any identification icon; and
the processing module 702 is further configured to, in response to an information adjustment operation for the resource processing window, adjust resource processing information displayed in the resource processing window.

In some examples, the processing module 702 is further configured to:
in response to a movement operation acting on a range skill control on the graphical user interface, adjust the resource processing information of the at least one resource processing node located within a coverage area of the range skill control.

In some examples, the processing module 702 is further configured to:
in response to a touch operation acting on a mode switching control on the graphical user interface, switch a game mode to a preset production mode in which other game information besides the plurality of resource processing nodes in the game scene is hidden.

Reference may be made to relevant descriptions in the foregoing embodiments for the implementation process and the implementation principle of the game resource processing apparatus according to the present embodiment, and details are not described herein again.

FIG. 14 shows a schematic structural diagram of a terminal device provided by an embodiment of the present disclosure, wherein the terminal device is a device having a data processing capability, such as a mobile phone, a game console, and a computer, and as shown in FIG. 14, the terminal device 80 includes: a processor 801, a memory 802, and a bus 803, the memory 802 storing machine-readable instructions executable by the processor 801 to perform the foregoing method embodiments when the terminal device 80 runs.

An embodiment of the present disclosure further provides a computer-readable storage medium that stores a computer program, and the computer program, when run by a processor, performs the foregoing method embodiments.

It may be clearly understood by those skilled in the art that, for convenience and brevity of description, for specific working processes of the system and the apparatus described above, reference may be made to corresponding processes in the method embodiments, and details are not described again in the present disclosure. In several embodiments provided by the present disclosure, it should be understood that the systems, apparatus, and methods disclosed may be implemented in other ways. The apparatus embodiments described above are merely illustrative. For example, the division of the modules is merely a logical function division, and there may be other division methods during actual implementation. For another example, a plurality of modules or components may be combined or integrated into another system, or some features may be omitted or not performed. Another point is that shown or discussed mutual coupling or direct coupling or communication connection may be implemented by means of some communication interfaces, and the indirect coupling or communication connection between the apparatuses or modules may be in an electrical, mechanical, or other form.

In addition, functional units in each embodiment of the present disclosure may be integrated into one processing unit, each unit may exist alone physically, or two or more units may be integrated into one unit. The functions, if implemented in the form of software functional units and sold or used as an independent product, may be stored in a computer-readable storage medium. Based on such understanding, the technical solution of the present disclosure essentially, or a part contributing to the prior art, or a part of the technical solution may be embodied in the form of a software product, and the computer software product is stored in a storage medium, and includes several instructions to cause a computer device (which may be a personal computer, a server, or a network device, etc.) to perform all or some of the steps of the methods described in the embodiments of the present disclosure. The aforementioned storage medium includes: any type of medium capable of storing a program code, such as a U disk, a mobile hard disk drive, a read-only memory (ROM), a random access memory (RAM), a magnetic disk, or an optical disk.

The above are only specific embodiments of the present disclosure, but the scope of protection of the present disclosure is not limited thereto, and any changes or substitutions that can easily be conceived of by those skilled in the art within the technical scope disclosed by the present disclosure should be included in the scope of protection of the present disclosure.

1. A game resource processing method, comprising:
determining, from among a plurality of resource processing nodes in a game scene, a downstream resource processing node corresponding to at least one resource processing node, an input resource of the corresponding downstream resource processing node being an output resource of the at least one resource processing node;
respectively connecting the at least one resource processing node and the corresponding downstream resource processing node to generate a virtual production line between the at least one resource processing node and the corresponding downstream resource processing node; and
displaying the virtual production line on a graphical user interface.

2. The method according to claim 1, wherein displaying the virtual production line on the graphical user interface comprises:
acquiring a resource production speed of the at least one resource processing node;
acquiring an animation speed of cyclical advancement of a unidirectional arrow on the virtual production line corresponding to the resource production speed, wherein the unidirectional arrow is directed from the at least one resource processing node to the corresponding downstream resource processing node; and
displaying the virtual production line on the graphical user interface at the animation speed of cyclical advancement.

3. The method according to claim 1, wherein respectively connecting the at least one resource processing node and the corresponding downstream resource processing node to generate the virtual production line between the at least one resource processing node and the corresponding downstream resource processing node comprises:
displaying an identification icon in a preset area of the at least one resource processing node; and
respectively connecting the identification icon of the at least one resource processing node and an identification icon of the corresponding downstream resource processing node to generate the virtual production line.

4. The method according to claim 3, further comprising:
acquiring resource production information of the at least one resource processing node and resource consumption information of the corresponding downstream resource processing node;
displaying the resource production information at a location corresponding to the identification icon of the at least one resource processing node; and
displaying the resource consumption information at a location corresponding to the identification icon of the corresponding downstream resource processing node.

5. The method according to claim 4, wherein the resource production information comprises resource production progress, and the resource consumption information comprises resource consumption progress;
wherein displaying the resource production information at the location corresponding to the identification icon of the at least one resource processing node comprises:
displaying the resource production progress on the identification icon of the at least one resource processing node; and
wherein displaying the resource consumption information at the location corresponding to the identification icon of the corresponding downstream resource processing node comprises:
displaying the resource consumption progress on the identification icon of the corresponding downstream resource processing node.

6. The method according to claim 4, wherein the resource production information further comprises resource stock, and the resource consumption information further comprises resource consumption state;
wherein displaying the resource production information at the location corresponding to the identification icon of the at least one resource processing node comprises:
displaying the resource stock in a preset range centered on the identification icon of the at least one resource processing node; and
wherein displaying the resource consumption information at the location corresponding to the identification icon of the corresponding downstream resource processing node comprises:
displaying the resource consumption state in a preset range centered on the identification icon of the corresponding downstream resource processing node.

7. The method according to claim 3, further comprising:
in response to a style change operation acting on any resource processing node among the at least one resource processing node, switching a display means of the identification icon of the at least one resource processing node.

8. The method according to claim 4, wherein displaying the virtual production line on the graphical user interface comprises:
acquiring a resource production capacity of the virtual production line according to the resource production information of the at least one resource processing node and the resource consumption information of the corresponding downstream resource processing node;
determining, according to the resource production capacity and a resource stock of the at least one resource processing node, a production state corresponding to the virtual production line; and
displaying the virtual production line on the graphical user interface in a display means corresponding to the production state.

9. The method according to claim 8, wherein displaying the virtual production line on the graphical user interface in the display means corresponding to the production state comprises:
displaying the virtual production line on the graphical user interface in a color corresponding to the production state.

10. The method according to claim 8, further comprising:
in response to determining that the production state is a production resource shortage state, displaying resource shortage prompt information on the identification icon of the at least one resource processing node, wherein, in the production resource shortage state, the at least one resource processing node provides resources to the corresponding downstream resource processing node by means of the resource stock.

11. The method according to claim 8, further comprising:
in response to determining that the production state is a production stagnation state, displaying production stagnation prompt information on the identification icon of the at least one resource processing node, wherein, in the production stagnation state, the at least one resource processing node cannot provide resources to the corresponding downstream resource processing node.

12. The method according to claim 3, wherein the method further comprises:
in response to a selection operation acting on any identification icon, canceling display of other virtual production lines besides the virtual production line to which the any identification icon is connected.

13. The method according to claim 12, further comprising:
in response to the selection operation for the any identification icon, displaying the other virtual production lines; or
in response to a touch operation acting on a blank area on the graphical user interface, displaying the other virtual production lines.

14. The method according to claim 12, further comprising:
in response to a selection operation acting on a callout detail control corresponding to the any identification icon, displaying a resource processing window of a resource processing node corresponding to the any identification icon; and
in response to an information adjustment operation for the resource processing window, adjusting resource processing information displayed in the resource processing window.

15. The method according to claim 1, further comprising:
in response to a movement operation acting on a range skill control on the graphical user interface, adjusting resource processing information of the at least one resource processing node located within a coverage area of the range skill control.

16. The method according to claim 1, further comprising:
in response to a touch operation acting on a mode switching control on the graphical user interface, switching a game mode to a preset production mode in which other game information besides the plurality of resource processing nodes in the game scene is hidden.

17. (canceled)

18. (canceled)

19. A non-transitory computer-readable storage medium, wherein the computer-readable storage medium stores a computer program, and the computer program, when executed by one or more processors collectively or individually, performs operations, the operations comprising:
determining, from among a plurality of resource processing nodes in a game scene, a downstream resource processing node corresponding to at least one resource processing node, an input resource of the corresponding downstream resource processing node being an output resource of the at least one resource processing node;
respectively connecting the at least one resource processing node and the corresponding downstream resource processing node to generate a virtual production line between the at least one resource processing node and the corresponding downstream resource processing node; and
displaying the virtual production line on a graphical user interface.

20. A system, comprising:
one or more processors;
one or more memories storing computer-executable instructions, which, when executed on any combination of the one or more processors, performs operations, the operations comprising:
determining, from among a plurality of resource processing nodes in a game scene, a downstream resource processing node corresponding to at least one resource processing node, an input resource of the corresponding downstream resource processing node being an output resource of the at least one resource processing node;
respectively connecting the at least one resource processing node and the corresponding downstream resource processing node to generate a virtual production line between the at least one resource processing node and the corresponding downstream resource processing node; and
displaying the virtual production line on a graphical user interface.

21. The system of claim 20, wherein, to display the virtual production line on the graphical user interface, the computer-executable instructions, which, when executed on any combination of the one or more processors, performs the operations comprising:
acquiring a resource production speed of the at least one resource processing node;
acquiring an animation speed of cyclical advancement of a unidirectional arrow on the virtual production line corresponding to the resource production speed, wherein the unidirectional arrow is directed from the at least one resource processing node to the corresponding downstream resource processing node; and
displaying the virtual production line on the graphical user interface at the animation speed of cyclical advancement.

22. The system of claim 20, wherein, to respectively connect the at least one resource processing node and the corresponding downstream resource processing node to generate the virtual production line between the at least one resource processing node and the corresponding downstream resource processing node, the computer-executable instructions, which, when executed on any combination of the one or more processors, performs the operations comprising:
displaying an identification icon in a preset area of the at least one resource processing node; and
respectively connecting the identification icon of the at least one resource processing node and an identification icon of the corresponding downstream resource processing node to generate the virtual production line.
